(19) United States
(12) Patent Application Publication
(10) Pub. No.: US 2006/0021569 A1
(43) Pub. Date: Feb. 2, 2006

(54) Immersion optics fluid dispenser

(76) Inventors: Bernard Petrillo, Rye, NY (US); Bruno Israel, Kinderhook, NY (US)

Correspondence Address: RHODES INSTRUMENT CORPORATION, 11 VIRGINIA ROAD, N. WHITE PLAINS, NY, 10603, US

(21) Appl. No.: 11/224,358

(22) Filed: Sep. 12, 2005

Related U.S. Application Data
(63) Continuation-in-part of application No. 10/604,569, filed on Jul. 30, 2003.

(51) Int. Cl. B05C 5/00

(52) U.S. Cl. 118/300

(57) ABSTRACT

To achieve high resolution, microscope users routinely employ immersion optics with associated immersion fluids. A non-interfering delivery system dedicated for inverted microscopes is herein described that accurately dispenses (and removes) a controlled amount of these fluids precisely at the proper specimen location.

### BACKGROUND OF INVENTION

1. Field of the Invention

This invention relates to the need to provide an instrument to simplify and accurately dispense and/or remove immersion fluid for microscope systems.

2. Description of Prior Art

To obtain higher resolution of images when performing microscope analyses, greater numerical apertures are desired. Implementing the use of immersion optics attains these goals.

This requires the user to place the immersion fluid between the objective front lens and the specimen to fully occupy the lens-to-specimen interface. (When using an upright microscope, the fluid drop is placed on the specimen. In the case of the inverted microscope, the drop is placed on the front lens surface.) Excessive fluid creates a sloppy working environment; too little fluid is deleterious to the purity of the optical system.

It is important that the microscope user maintain continuous eye-to-specimen contact during the fluid application to eliminate a visual search procedure to relocate the item of interest. Similarly, no repositioning of the stage should occur so that the field-of-view remains unchanged.

It should be noted that a common operational procedure is to rotate the objective turret to a low power objective for general scanning. Once an item of interest is established, the higher-powered immersion objective is rotated into use. This back-and-forth search and analysis method is repeated continuously and demands that the dispensing system can operate without requiring the user to interrupt his eye-to-specimen contact.

While this fluid-dispensing chore can be manually performed easily when using upright microscopes, the task can be exceedingly difficult for an inverted system. The stage of the inverted system presents a mechanical hindrance limiting the viewing and physical access to the lens location. Since the lens is located below and/or internal to the stage, the operator cannot see the lens. The operator is required to awkwardly bend over and then to attempt to apply the fluid to the partially obscured lens. Further, it is not feasible to rotate the lens turret for the application of the fluid, since the lens surface will not then be parallel to the x-y plane and the fluid will tend to run off the lens.

Amos U.S. Pat. No. 3,837,731 achieved the fluid application by designing a mechanical enclosure that is rigidly attached to the objective lens. This combined assembly is lowered to the specimen to totally engulf the lens-to-specimen interface. The immersion fluid is then pumped into the enclosed space. The shortcomings of this approach are many; it is not compatible with today's objective turrets, does not permit easy interchange of objective lenses, must be selectively tailored to fit different microscopes/lenses, a direct view of the specimen is obscured, and it is not applicable for inverted microscopes.

Fowler U.S. Pat. No. 5,574,594 has established a marking system that could double as a fluid dispenser at the specimen's point of interest. However, this method mimics the Amos mechanical marriage to the objective lens and therefore has similar disadvantages. In addition, mechanical interferences negate this approach when using high power objectives with their small working distances.

None of these systems has an integrated extraction capability or can be mechanically interfaced with turreted objective lens assemblies.

Hodges U.S. Pat. No. 5,066,114 has arrived at a high-refractive objective lens system wherein the fluid is contained internally in a multiple lens array and completely fills the chamber containing these lenses. It essentially develops a dedicated, inflexible microscope that is pre-configured for a singular application. While this is an integrated immersion optics system, the concept is not applicable or adaptable to the general family of commercially available microscopes.

Reiner U.S. Pat. No. 6,196,686 presents a design that is dedicated to the viewing of the inside of an eye. It requires the replacement of the simple objective lens with a compound marriage of additional lens, fiber optic illumination, and fluid ducting. The goal is to allow surgical procedures to performed to the eye with enhanced suppression of light reflections and in a non-interfering manner. This system is not applicable to general analyses of specimen slides by conventional microscopes.

Bowman U.S. Pat. No. 5,233,197 uses a computer-driven system to position the objective lens at a desired location on the specimen slide. There is no requirement to perform this action when using a microscope for general immersion optical analysis. It is only important to fill the interface with immersion fluid between the objective lens and the specimen without regard to their relative locations.

Rolland (2004/0180299A1) has generated a lithography system that uses immersion optics to attain high numerical apertures. The theme of this patent is the use of immersion optics as applied to semiconductor lithography. No mechanism is described that simply deposits or removes the array of immersion fluids mentioned. The primary extraction technique employed is to use carbon dioxide to remove or dry the fluid on the semiconductor substrate.

Mcleod U.S. Pat. No. 2,637,244 describes a remote fluid delivery system that deposits a reagent onto a specimen to perform a reaction analysis. While the design of this system can be extrapolated to meet the demands of an immersion optics system for upright microscopes, it fails to be adaptable for inverted microscopes. This upright scope has an optical system that looks down at a stage-mounted specimen utilizing illumination from above the specimen (reflected light) or from below the specimen (transmitted light). The inverted scope has an optical system that looks up at the bottom of a prepared specimen. The system concepts described in Mcleod are uniquely and only applicable for upright microscopes. In this application, a reagent is deposited on a specimen and then the subsequent reaction is analyzed. For an upright scope, once the fluid drop is released, gravity guides the drop to the desired location on the topside of the specimen. For an inverted scope, this approach is not viable since there is no attractive force to guide and maintain the drop to the desired bottom side location.

The delivery system herein described has the prime objective of modifying the numerical aperture of the optical system. To achieve this result for upright microscopes, the fluid is conventionally deposited on the specimen. However, this approach is not viable for an inverted microscope system since the immersion fluid would have to be deposited and remain on the bottom surface of the specimen.

In this system, depositing the fluid directly on the objective lens rather than the specimen attains the desired goal. The objective lens/bubble combination is then raised up to the bottom of the specimen eliminating the air interface between the specimen and the lens. The replacement of the immersion fluid for the former airspace between the specimen and the objective lens satisfies the goal of increasing the numerical aperture of the optical system.

The fluid dispensing capabilities of Mcleod cannot achieve the requisite goals of an immersion optics inverted microscope because of the mechanical constrictions associated with a turreted lens system and the constraints imposed by the small working distances (100 to 300 microns).

The rotational plane of the turret is not parallel to the specimen; it is offset at 30 degrees. Hence, only the objective lens on the optical axis will have its top surface parallel to the specimen. Rotating the desired objective lens away from the optical axis for application of the fluid is not feasible since the lens surface will not then be perpendicular to the earth's gravitational field and the fluid will run off.

The need for a simple, mechanically non-invasive system to accomplish the placement and removal of immersion fluid for the universal family of microscopes (i.e. both upright and inverted) remains an unsatisfied task.

### 3. DETAILED DESCRIPTION

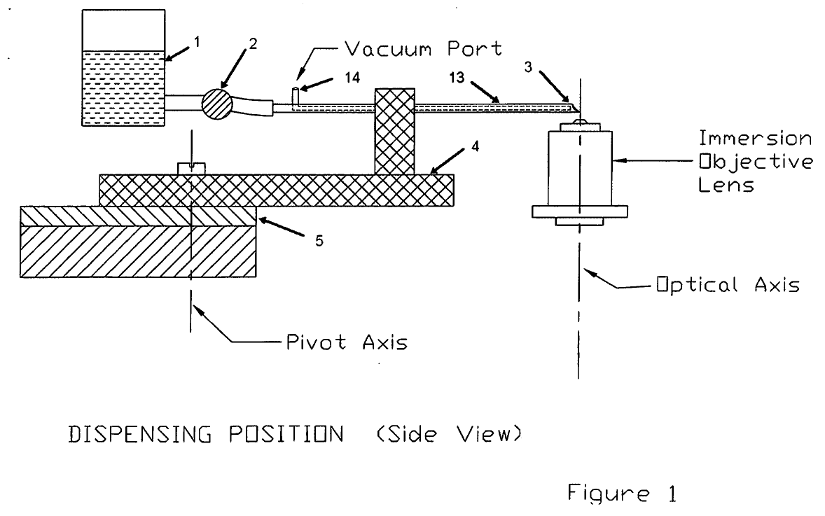

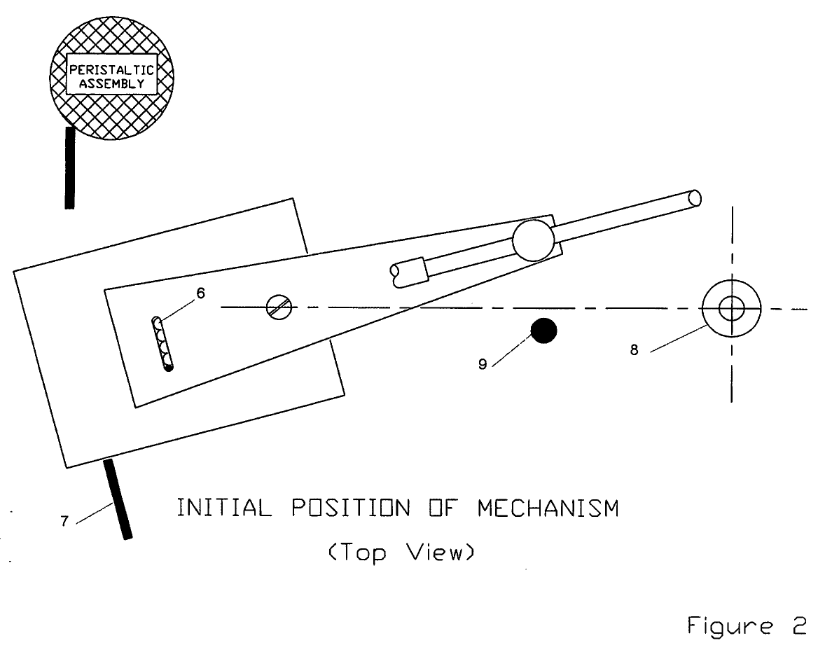

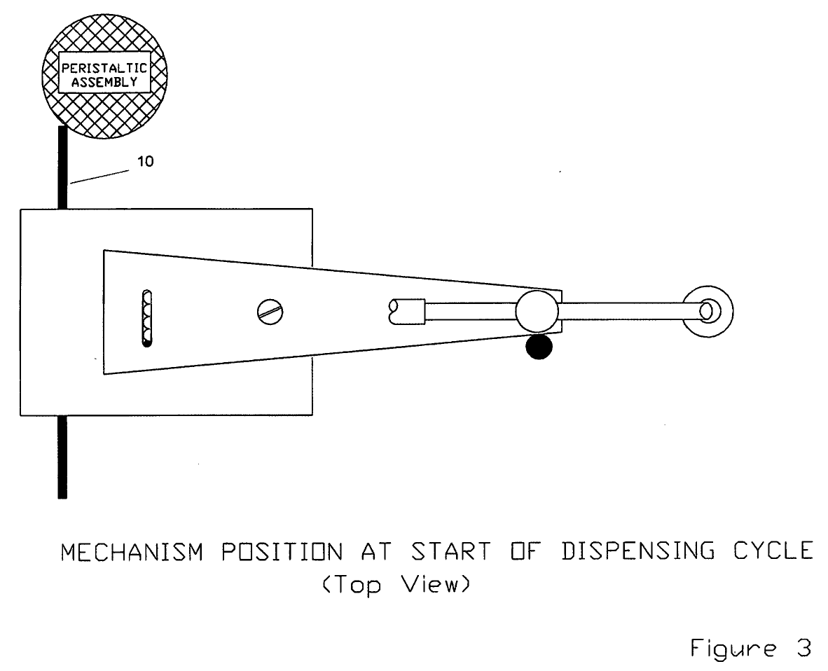

FIG. 1 is a functional diagram of the dispensing system for an inverted microscope. The desired immersion fluid is contained in the reservoir 1. Whenever the peristaltic driver is actuated, fluid is drawn into the peristaltic processing chamber 2 and pushed out through the dispensing port 3. The mechanical actuator is a two-stage device with an upper section 4 and a lower section 5. Both sections share a common pivotal axis. The upper section contains a constrained spring 6 that initially forces the upper section to rotate in concert with the lower section.

As the flexible driving plunger 7 is initially displaced, it rotates the complete assembly about the pivot and positions the output port of the fluid dispenser into position above the front objective lens 8. At this point, the upper section encounters the fixed stop 9 and ceases rotating. Further displacement of the plunger causes the lower section to overcome the spring's static force. The lower section continues to rotate and a linear actuator 10 drives the ratcheting roller bearing assembly 11. By peristaltic action, the immersion fluid is squeezed from the peristaltic chamber 12 out through the dispenser outlet port.

The fluid removal process mimics the mechanical positioning events of the dispensing cycle. However, when the coaxial arm 13 is in position over the lens, a vacuum source is activated at the vacuum port 14 that causes the previously deposited fluid to be extracted from the lens surface.

For upright microscope systems, the same operational sequence of events would be invoked. However, the fluid would be deposited on the specimen slide rather than the objective lens surface.

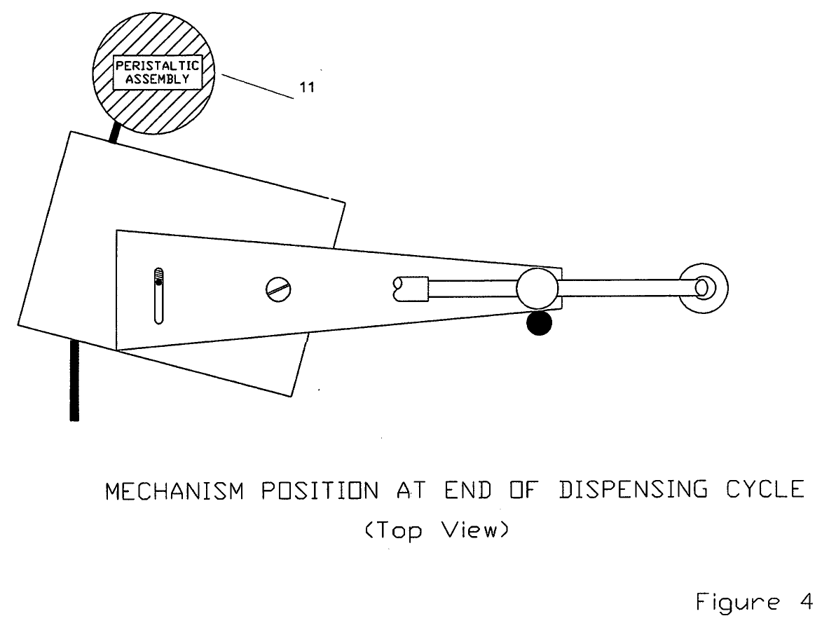

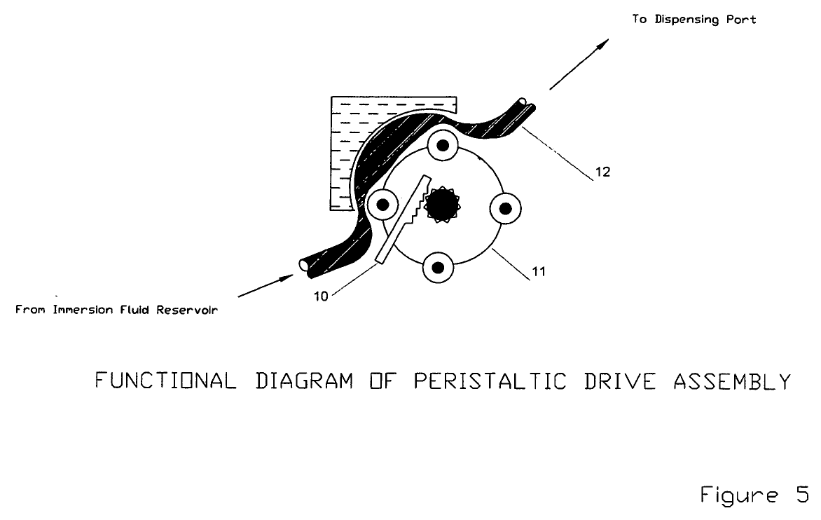

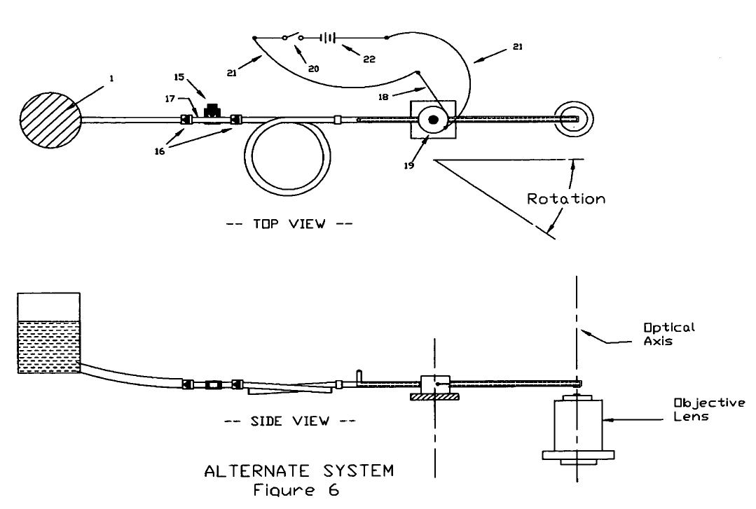

An alternate approach to accomplish the stated objective of satisfying the immersion fluid dispensing for inverted microscopes is shown in FIG. 6. The peristaltic pump previously described is replaced with a pinch valve 15 and two miniature check valves 16. The two check valves are configured to only allow a flow direction from the reservoir to the dispensing port. When the solenoid-driven pinch valve is actuated, the flexible flow tube between the check valves 17 is compressed and a portion of the fluid that was contained in this section is forced out of the downstream check valve. Actuation of the pinch valve is repeated until the desired amount of fluid is dispensed.

In addition, the mechanical drive system is replaced with a novel electrical technique. Utilization is made of Nitinol wire. (This wire has been patented by Buehler U.S. Pat. No. 3,174,851, and has the unique property of contracting when excited by a direct current power source.) As shown in FIG. 6, this Nitinol wire 18 is partially wrapped around the cylindrical mount 19 supporting the dispensing tube assembly. Closing the switch 20 causes direct current to flow from the power supply 22 through the flexible wires 21 in series with the Nitinol wire. The resulting wire contraction rotates the dispensing tube into the desired position for depositing fluid on the objective lens.

What is claimed is:

1. An immersion fluid dispenser comprising:
A remotely located delivery system uniquely dedicated for inverted microscopes that does not require an alteration or mechanical attachment to the microscope's optical components.

2. (canceled)

3. (canceled)

4. The immersion fluid dispenser of claim 1 further comprising:
An accurate fluid dispenser utilizing a peristaltic pump/stepping motor design.

5. The immersion fluid dispenser of claim 1 further comprising:
An alternate fluid dispenser wherein the positioning of the dispenser nozzle is achieved by the use of Nitinol wire.

6. The fluid dispenser of claim 1 further comprising:
A pump system using a pinch valve in combination with check valves.
